(19) United States
(12) Patent Application Publication
(10) Pub. No.: US 2011/0201662 A1
(43) Pub. Date: Aug. 18, 2011

(54) METHOD FOR PRODUCING XPS MOULDED PIECES PROVIDED WITH INSECTICIDE

(75) Inventors: Michael Ishaque, Mannheim (DE); Olaf Kriha, Neustadt (DE); Klaus Hahn, Kirchheim (DE); Daniela Longo, Sankt Augustin (DE)

(73) Assignee: BASF SE, Ludwigshafen (DE)

(21) Appl. No.: 13/124,979

(22) PCT Filed: Oct. 21, 2009
(86) PCT No.: PCT/EP09/63780

§ 371 Date: Apr. 19, 2011

(30) Foreign Application Priority Data
Oct. 22, 2008 (EP) 08167227.1

(51) Int. Cl. A01N 43/56; A01P 7/04; C08J 9/12

(52) U.S. Cl. 514/407; 264/54

(57) ABSTRACT

Process for the production of insecticide-modified extruded polystyrene foam (XPS) preforms, comprising the steps
(a) heating polystyrene (PS) until a polymer melt is formed,
(b) introducing a blowing agent into the polymer melt to form a foamable melt, and
(c) foaming the foamable melt to give an XPS preform,
   where at least one insecticide from the group of the phenylpyrazoles, chlorfenapyr and hydramethylnone is introduced into the polymer melt in at least one of steps (a) and/or (b).

The invention relates to a process for the preparation of insecticide-modified foam preforms of extruded polystyrene foam (XPS preforms), to insecticidal XPS preforms obtainable by the process, and to their use in the building trade.

Polymer foams and foam preforms are used both below and above ground as insulation material in the construction industry, for example. Insects, in particular termites, can inflict substantial feeding damage on such foams, so that the insulation effect and the mechanical stability of the preforms are limited and further advancing of the pests is made possible. In many cases, an insecticidal protection of preforms is stipulated by the law, since such insulation materials constitute a preferred environment for termites.

JP-2000-001564 describes the use of (±)-5-amino-1-(2,6-dichloro-α,α,α,-trifluoro-p-tolyl)-4-trifluoromethylsulfinylpyrazole (Common Name: fipronil) for the protection of polymer foams. To this end, fipronil is employed in concentrations of from 0.001-1% by weight. Polystyrene, polyethylene and polypropylene are described as polymer matrix. Fipronil is incorporated by applying to the surface of the prefoamed foam particles, or by applying to the blowing agent-comprising granules. JP 2001-259271 describes a process in which blowing agent-comprising EPS granules or prefoamed EPS granules are coated with fipronil and a binder.

WO 00/44224 discloses the preparation of insecticide-modified polymer foam sheets by extruding or pressing an expandable polymer composition which comprises, dispersed into it, an insecticide from the pyrethroid group. The process described relates to the preparation of XPS (extruded polystyrene foam). The active substances employed differ markedly from the active substances according to the invention with regard to their structure. Moreover, the insecticidal activity of the foams described therein with respect to insects is not satisfactory.

It is an object of the invention to do away with the abovementioned disadvantages and to provide an economical process for the production of XPS preforms with a sustained and improved insecticidal activity.

It has been found that insecticidal active substances according to the invention can be incorporated homogeneously into a polymer melt without decomposition.

The invention therefore relates to a process for the preparation of insecticide-modified extruded polystyrene foam (XPS) preforms, comprising the steps
(a) heating polystyrene (PS) until a polymer melt is formed,
(b) introducing a blowing agent into the polymer melt to form a foamable melt, and
(c) foaming the foamable melt to give an XPS preform,
   where at least one insecticide from the group of the phenylpyrazoles, chlorfenapyr and hydramethylnone is introduced into the polymer melt in at least one of steps (a) and/or (b).

The invention furthermore relates to XPS preforms obtainable by the process according to the invention, and to their use as construction material, in particular as insulation material, in the building trade.

In the XPS preforms prepared by the process according to the invention, the insecticide is incorporated into the polymer matrix in a particularly stable and uniform manner. This reduces active substance losses and exposure to the insecticide during the preparation, processing and use of the XPS preforms. Moreover, the process according to the invention makes it possible to reduce the amount of insecticide required.

Moreover, the insecticide-modified XPS preforms according to the invention do not have any disadvantages regarding their mechanical properties and insulation properties in comparison with a standard product (without insecticide).

For the purposes of the invention, polystyrene (PS) is used as umbrella term for homo- and copolymers of styrene, other vinyl-aromatic monomers and, if desired, further comonomers. PS is understood as meaning, for example, standard polystyrene (general purpose polystyrene, GPPS, usually transparent), high-impact polystyrene (HIPS, comprising, for example, polybutadiene or polyisoprene rubber), styrene/maleic (anhydride) polymers, acrylonitrile/butadiene/styrene polymers (ABS), styrene/acrylonitrile polymers (SAN), α-methylstyrene/acrylonitrile polymer (AMSAN), or mixtures of these (component K1). Preferred PS is standard polystyrene, i.e. a polystyrene with a molar styrene monomer content of at least 95%. Furthermore preferred PS is α-methylstyrene/acrylonitrile polymer (AMSAN).

Moreover, PS also comprises blends of one or more of the abovementioned polymers (component C1) with one or more thermoplastic polymers (component C2) such as, for example, polyphenylene ethers (PPE), polyamides (PA), polyolefins such as polypropylene (PP) or polyethylene (PE), polyacrylates such as polymethyl methacrylate (PMMA), polycarbonates (PC), polyesters such as polyethylene terephthalate (PET) or polybutylene terephthalate (PBT), polyether sulfones (PES), polyether ketones (PEK) or polyether sulfides (PES).

The abovementioned polymers of component C1 are obtainable by polymerization of one or more vinyl-aromatic monomers such as styrene and, if desired, further comonomers such as dienes, α,β-unsaturated carboxylic acids, esters (preferably alkyl esters) or amides of these carboxylic acids and alkenes. Suitable polymerization methods are known to the skilled worker.

It is preferred to choose, as vinyl-aromatic monomer, at least one compound of the general formula (I)

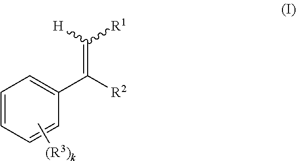

in which R¹ and R² independently of one another are in each case hydrogen, methyl or ethyl;

R³ is hydrogen, C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably C₁-C₄-alkyl such as methyl, ethyl, n-propyl, isopropyl, n-butyl, isobutyl, sec-butyl and tert-butyl; and

k is an integer from 0 to 2.

R¹ and R² are in each case preferably hydrogen, and more preferably k=0, Styrene is especially preferred; others which are especially suitable are α-methylstyrene, p-methylstyrene, ethylstyrene, tert-butylstyrene, vinylstyrene, α-vinyltoluene, 1,2-diphenylethylene, 1,1-diphenylethylene or mixtures of these.

Suitable diene comonomers are all polymerizable dienes, in particular 1,3-butadiene, 1,3-pentadiene, 1,3-hexadiene, 2,3-dimethylbutadiene, isoprene, piperylene or mixtures of these. Preferred are 1,3-butadiene (short: butadiene), isoprene, or mixtures of these.

Compounds which are preferably suitable as α,β-unsaturated carboxylic acid or its derivatives are those of the general formula (II)

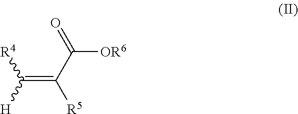

in which the symbols have the following meanings:

R⁵ is selected from the group consisting of
unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl;
or hydrogen,
very especially preferred are hydrogen and methyl;

R⁴ is selected from the group consisting of
unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl,
hydrogen is very especially preferred;

R⁶ is selected from the group consisting of
hydrogen (in which case compound (II) is the carboxylic acid itself),
or unbranched or branched C₁-C₁₀-alkyl (in which case compound II is a carboxylic ester) such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl; and 2-ethylhexyl.

Preferred compounds of the formula (II) are acrylic acid and methacrylic acid. Furthermore preferred are the C₁-C₁₀-alkylesters of acrylic acid, in particular the butylesters, preferably n-butyl acrylate, and the C₁-C₁₀-alkylesters of methacrylic acid, in particular methyl methacrylate (MMA).

Suitable carboxamides are in particular the amides of the abovementioned compound (II), for example acrylamide and methacrylamide.

Also suitable as monomers are compounds of the general formula (IIIa) and (IIIb), the compounds (IIIa) formally being OH-substituted carboxamides:

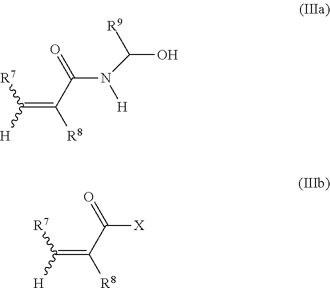

in which the symbols denote:

R⁸ is selected from the group consisting of
unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl;
or hydrogen;
very especially preferred are hydrogen and methyl;

R⁷ is selected from the group consisting of
unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl;
hydrogen is very especially preferred;

R⁹ is selected from among
unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl,
hydrogen is very especially preferred;

X is selected from the group consisting of
hydrogen,
glycidyl
groups with tertiary amino groups, preferably NH(CH₂)_{b}—N(CH₃)₂, where b is an integer in the range of from 2 to 6,
enolizable groups with 1 to 20 C atoms, preferably acetoacetyl, of the formula

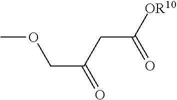

where

R¹⁰ is selected from among unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; especially preferably C₁-C₄-alkyl such as methyl, ethyl, n-propyl, isopropyl, n-butyl, isobutyl, sec-butyl and tert-butyl.

R⁸ in formula (IIIa) or (IIIb), respectively, is very especially preferably selected from among hydrogen and methyl, and R⁷ and R⁹ are in each case hydrogen.

Particularly preferred as compound of the formula (Va) is methylolacrylamide.

The PS may also be prepared using alkenes as comonomers. Particularly suitable alkenes are ethylene (ethene) and propylene (propene).

Further suitable comonomers for the preparation of component C1 are, for example, in each case from 1 to 5% by weight of (meth)acrylonitrile, (meth)acrylamide, ureido(meth)acrylate, 2-hydroxyethyl(meth)acrylate, 3-hydroxypropyl(meth)acrylate, acrylamidopropanesulfonic acid (branched or unbranched), or the sodium salt of vinylsulfonic acid.

The polystyrenes (PS) which can be employed in accordance with the invention can be prepared by processes known to the skilled worker, for example by free-radical polymerization, anionic polymerization or cationic polymerization, neat, in solution, dispersion or emulsion. Free-radical polymerization is preferred.

The polystyrenes which can be employed in the process according to the invention have, in general, weight-averaged molecular weights of from 100 000 to 300 000 g/mol and an MVR melt volume rate (200° C./5 kg) determined as specified in ISO 113 in the range of from 1 to 10 cm³. Examples of suitable polystyrenes are PS 158 K, 168 N or 148G from BASF SE.

In step (a) of the process according to the invention, the polystyrene is heated to give a polymer melt. By formation of a polymer melt, there is understood, for the purposes of the present invention, a plastification of the polystyrene in the wider sense, i.e. the conversion of the solid polystyrene into a shapable or flowable state. To this end, it is necessary to heat the polystyrene to a temperature of above the melting point or the glass transition temperature. Suitable temperatures are, in general, from 50 to 250° C., preferably from 100 to 220° C., especially preferably from 180 to 220° C. If a polystyrene with a molar styrene monomer content of 95% is employed, it must be heated to a temperature of at least 180° C. in order to give a polymer melt.

The heating of the polystyrene (step (a) of the process according to the invention) can be carried out by means of any devices known in the art, such as by means of an extruder, mixer (for example kneader). It is preferred to employ compounding extruders (primary extruders). Step (a) of the process according to the invention can be carried out continuously or batchwise, a continuous process being preferred.

Step (b) of the process according to the invention comprises the introduction of a blowing agent into the polystyrene molten in step (a), in order to form a foamable melt.

The blowing agent can be introduced into the molten polystyrene by any method known to the skilled worker. Suitable examples are extruders or mixers (for example kneaders). In a preferred embodiment, the blowing agent is mixed with the molten polystyrene under elevated pressure. Here, the pressure must be high enough that foaming of the molten polymer material is essentially prevented and a homogeneous distribution of the blowing agent in the molten polystyrene is obtained. Suitable pressures are from 50 to 500 bar (absolute), preferably from 100 to 200 bar (absolute), especially preferably 120-170 bar (absolute). The temperature in step (b) of the process according to the invention must be chosen such that the polymeric material is present in the molten state. Therefore, step (b) of the process according to the invention is generally carried out at temperatures of from 100 to 280° C., preferably from 120 to 260° C. and especially preferably from 180 to 220° C. Step (b) can be carried out continuously or batchwise; step (b) is preferably carried out continuously.

The addition of the blowing agent can be effected in the compounding extruder (primary extruder) or in a subsequent step.

In a preferred embodiment, the foamable polymer melt is produced in XPS extruders which are known to the skilled worker, for example via a tandem arrangement of compounding extruder (primary extruder) and cooling extruder (secondary extruder). The process can be carried out continuously or batchwise, the polystyrene being melted in the primary extruder (step (a)) and the addition of the blowing agent (step (b)) for forming a foamable melt also being carried out in the primary extruder.

Thereafter, the melt which is provided with blowing agent is cooled in the secondary extruder to a temperature of 50-180° C., preferably to a temperature of 80-130° C., which is suitable for foaming.

Suitable blowing agents comprise inorganic, organic and chemically reactive blowing agents. Suitable inorganic blowing agents comprise carbon dioxide, nitrogen, argon, water, air and helium. A preferred blowing agent is a mixture of carbon dioxide and water.

Organic blowing agents comprise aliphatic hydrocarbons with 1 to 9 carbon atoms and perhalogenated or partially halogenated aliphatic hydrocarbons with 1 to 4 carbon atoms. Aliphatic hydrocarbons comprise methane, ethane, propane, n-butane, isobutene, n-pentane, isopentane and neopentane. Fully and partially halogenated aliphatic hydrocarbons comprise fluorocarbon compounds, chlorocarbon compounds and chlorofluorocarbon compounds. Examples of fluorocarbon compounds comprise methyl fluoride, perfluoromethane, ethyl fluoride, difluoromethane, 1,1-difluoroethane, 1,1,1-trifluoroethane, 1,1,1,2-tetrafluoroethane, pentafluoroethane, difluoromethane, perfluoroethane, 2,2-difluoropropane, 1,1,1-trifluoropropane, perfluoropropane, difluoropropane, difluoropropane, perfluorobutane, perfluorocyclopentane. Partially halogenated chlorocarbon compounds and chlorofluorocarbon compounds which are suitable for use in the process according to the invention comprise methyl chloride, methylene chloride, ethyl chloride, 1,1,1-trichloroethane, chlorodifluoromethane, 1,1-dichloro-1-fluoroethane, 1-chloro-1,1-difluoroethane, 1,1-dichloro-2,2,2-trifluoroethane and 1-chloro-1,2,2,2-tetrafluoroethane. Fully halogenated chlorofluorohydrocarbon compounds comprise trichloromonofluoromethane, dichlorodifluoromethane, trichlorotrifluoroethane, 1,1,1-trifluoroethane, pentafluoroethane, dichlorotetrafluoroethane, chloroheptafluoropropane and dichlorohexafluoropropane.

Chemically reactive blowing agents comprise azodicarboxylic diamide, azodiisobutyronitrile, benzene sulfone hydrazide, 4,4-oxybenzenesulfonyl semicarbazide, p-toluenesulfonyl semicarbazide, barium azodicarboxylate, N,N′-dimethyl-N,N′-dinitrosotherephthalamide and trihydrazinotriazine.

A further preferred blowing agent mixture comprises from 0 to 100% by weight of carbon dioxide, from 0 to 50% by weight of water and from 0 to 75% by weight of an alcohol, for example methanol or ethanol, of a ketone or of an ether.

For environmental reasons, it is desirable to employ inorganic blowing agents, if this is possible. Two especially suitable inorganic blowing agents are carbon dioxide and water.

The amount of the blowing agent employed is from 0.5 to 20% by weight, preferably from 4 to 12% by weight and in particular from 2 to 8% by weight, based on the polystyrene employed.

In a further preferred embodiment, at least one nucleating agent is added to the molten polymeric material. Nucleating agents which can be employed are finely divided, inorganic solids such as talc, metal oxides, silicates or polyethylene waxes in amounts of, in general, from 0.1 to 10% by weight, preferably from 0.1 to 3% by weight, especially preferably from 1 to 1.5% by weight, based on the polymeric material. The mean particle diameter of the nucleating agent is, as a rule, in the range of from 0.01 to 100 μm, preferably from 1 to 60 μm. An especially preferred nucleating agent is talc, for example talc from Luzenac Pharma. The nucleating agent can be added to the polymer melt by methods known to the skilled worker. The addition may be carried out in step (a) and/or (b).

If desired, further additives such as nucleating agents, plasticizers, flame retardants, IR absorbers such as carbon black or graphite, aluminum powder and titanium dioxide, soluble and insoluble colorants and pigments may be added in step (a) and/or (b). Preferred additives are graphite and carbon black.

It is especially preferred to add graphite in amounts of, in general, from 0.05 to 25% by weight, especially preferably in amounts from 2 to 8% by weight, based on the polymeric material. Suitable particle sizes for the graphite employed are in the range of from 1 to 50 μm, preferably in the range from 2 to 10 μm.

In one embodiment, the XPS preform according to the invention can be colored in order to make it readily distinguishable from non-insecticide-modified XPS preforms and thus to increase product safety.

Owing to fire protection regulations in the construction industry and in other industries, one or more flame retardants are added in step (a) and/or (b). Examples of suitable flame retardants are tetrabromobisphenol A diallyl ether, expandable graphite, red phosphorus, triphenyl phosphate and 9,10-dihydro-9-oxa-10-phosphaphenanthrene 10-oxide. A further suitable flame retardant is, for example, hexabromocyclododecane (HBCD), in particular the technical grade products which comprise essentially the α-, β- and γ-isomer and preferably an addition of dicumyl peroxide as synergist.

In the process according to the invention, at least one insecticide from the group of the phenylpyrazoles, in particular fipronil (IV), acetoprole, ethiprole (V) and the compound of the formula (VI), chlorfenapyr (VII) and hydramethylnone (VIII), are admixed to the polymer melt employed. Admixing can be carried out in steps a) and/or b).

The addition of the at least one insecticide is not critical here, thus, the at least one insecticide can be effected as a pure substance, as a formulation or in the form of a masterbatch. It is also possible to employ, in step a), a PS which already comprises at least one insecticide.

For the purposes of the present invention, pure substances are understood as meaning substances with an active substance content of at least 80% by weight, preferably at least 90% by weight, more preferably at least 95% by weight and in particular preferably at least 97% by weight, in each case based on the total weight of the pure substances.

Formulations are understood as meaning all known insecticide formulations with which the skilled worker is familiar. The use of commercially available formulations is also possible. The use of aqueous formulations is preferred.

Masterbatches are understood as meaning PSs which comprise the at least one insecticide at a concentration which is higher than the final concentration. The final concentration is understood as meaning the concentration of the at least one insecticide in the XPS preform. Suitable insecticide concentrations for a masterbatch are in the range of from 1 to 90% by weight. Preferably, the masterbatch comprises less than 20% by weight, more preferably from 1 to 15% by weight and in particular from 5 to 10% by weight of the at least one insecticide, in each case based on the total weight of the masterbatch.

Suitable processes for preparing a masterbatch are, for example, the incorporation of the at least one insecticide into a polymer melt in an extruder or the coating of PS with an insecticide or an insecticide mixture.

Suitable mixing ratios of the masterbatch and the commercially available PS which is employed in the process according to the invention are in the range of from 10:1 to 1:1000, especially preferably in the range of from 10:1 to 1:100 and in particular in the range of from 10:1 to 1:50.

The admixing of the at least one insecticide is preferably effected in step (a). In one embodiment, the at least one insecticide is added as pure substance in step (a) and/or (b). In a further embodiment, the addition of the at least one insecticide is effected in step (a) and/or (b) in the form of an aqueous formulation.

In a further embodiment, the at least one insecticide is incorporated, into a polymer melt, in an extruder at a concentration which is higher than the final concentration (preparation of a masterbatch) and this active-substance-comprising polymer is subsequently fed to the polymer melt in step (a) and/or (b). The feeding can be effected for example by mixing into the main stream of the polymers, shortly after melting or via a secondary stream which serves for conveying additives into the main stream.

In a further embodiment, the preparation of the batch is effected by coating a PS with an insecticide or insecticide mixture. It is preferred to use PS granules for this purpose. In this context, the coating process is carried out by known methods with which the skilled worker is familiar. In this context, the insecticide, or the insecticide mixture, can be used in solid, dissolved and/or dispersed (for example suspended or emulsified) form. The insecticide, or the insecticide mixture, is applied to the PS to be coated for example by spraying or applying in drums, using customary mixers. Another possibility is the immersion or wetting of the PS in a suitable solution, dispersion, emulsion or suspension. If desired, further coating additives such as binders, antistatics, hydrophobicizing agents, flame retardants, finely divided silica and inorganic fillers may be added to the insecticide, or the insecticide mixture.

In one embodiment, the coated PS thus obtained is melted together with commercially available uncoated PS by methods known to the skilled worker, for example in an extruder, and processed by the process according to the invention to give XPS preforms. The addition of the coated PS to the commercially available uncoated PS is preferably carried out in this context in step (a) of the process according to the invention. It is also possible to mix the coated and the commercially available uncoated PS in a preceding step and then to feed into step (a). In a preferred embodiment, the at least one insecticide is added as pure substance in step (a). In a further preferred embodiment, the at least one insecticide is added in step (a) in the form of a formulation.

In an especially preferred embodiment, the at least one insecticide is added in step (a) in the form of an aqueous formulation.

The added amount of the at least one insecticide in step (a) and/or (b) can be chosen at will, but is preferably chosen such that the XPS preform according to the invention has insecticide concentrations of from 10 to 1000 ppm, especially preferably from 20 to 1000 ppm and in particular from 50 to 500 ppm, based on the XPS preform.

Suitable insecticides are phenylpyrazoles, in particular fipronil ((±)-5-amino-1-(2,6-dichloro-α,α,α,-trifluoro-p-tolyl)-4-trifluoromethylsulfinylpyrazole), hydramethylnone and chlorfenapyr.

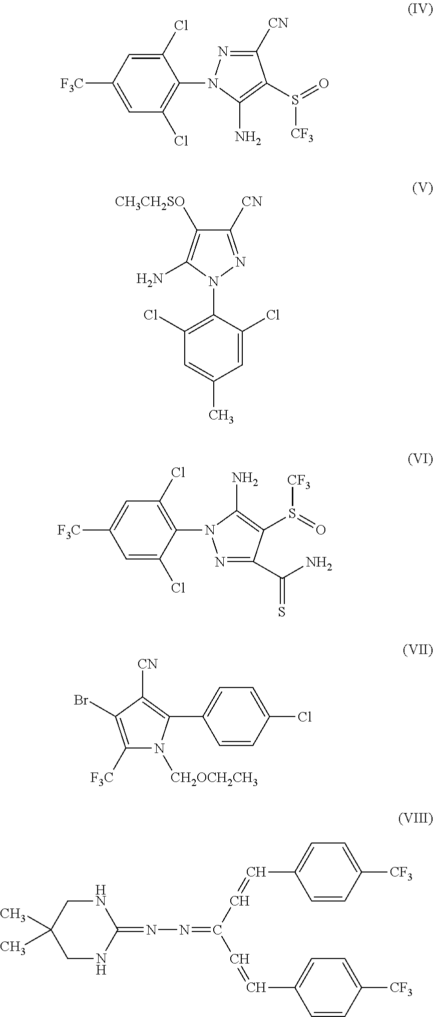

Fipronil is especially preferred.

The compounds mentioned, in particular those of the formulae (II), (III), (V) and (VI), and their preparation are known and described, for example, in “The Pesticide Manual”, 14^{th} Edition, British Crop Protection Council (2006). The thiamide of the formula (IV) and its preparation is described in WO 98/28279. Fipronil, hydramethylnone and chlorfenapyr are commercially available from BASF SE (Ludwigshafen, Germany).

Besides the abovementioned insecticides, further insecticides, biocides or fungicides may be added (in a mixture).

Suitable mixing partners are, for example, from the group of the insecticides:

I.1. organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isofenphos, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
I.2. carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
I.3. pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
I.4. growth regulators: a) chitin synthesis inhibitors: benzoylureas: chlorfluazuron, diflubenzuron, flucycloxuron, flufenoxuron, hexaflumuron, lufenuron, novaluron, noviflumuron, sulfluramid, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
I.5. nicotin receptor agonists/antagonists: acetamiprid, clothianidin, dinotefuran, imidacloprid, nitenpyram, thiacloprid, thiamethoxam;
I.6. GABA antagonists: endosulfan, pyrafluprole, pyriprole;
I.7. macrocyclic lactone insecticides: abamectin, emamectin, milbemectin, lepimectin, spinosad;
I.8. site-I electron transport inhibitors:
for example fenazaquin, fenpyroximate pyrimidifen, pyridaben, tebufenpyrad, tolfenpyrad, flufenerim, hydramethylnon, dicofol;
I.9. site-II and Site-III electron transport inhibitors:
acequinocyl, fluacyprim, rotenone;
I.10. compounds which inhibit oxidative phosphorylation: cyhexatin, diafenthiuron, fenbutatin oxide, propargite;
I.11. chitin biosynthesis inhibitors:
cyromazine;
I.12. mixed function oxidase inhibitors:
piperonyl butoxide (PBO);
I.13. sodium channel modulators:
indoxacarb, metaflumizone;
I.14. active substances with unknown or unspecific mechanisms of action:
amidoflumet, benclothiaz, bifenazate, borate, cartap, chlorantraniliprole, flonicamid, pyridalyl, pymetrozine, sulfur, thiocyclam, flubendiamide, cyenopyrafen, cyflumetofen, flupyrazofos.

The commercially available compounds of group I.1 to I.15 can be found in “The Pesticide Manual”, 14^{th} Edition, British Crop Protection Council (2006).

Lepimectin is known from “Agro Project”, PJB Publications Ltd, November 2004. Benclothiaz and its preparation are described in EP-A1 454621. Methidathione and paraoxone and their preparation is described in “Farm Chemicals Handbook”, Volume 88, Meister Publishing Company, 2001. Acetoprole and its preparation are described in WO 98/28277. Flupyrazofos is described in “Pesticide Science” 54, 1988, pages 237-243 and in U.S. Pat. No. 4,822,779. Pyrafluprole and its preparation are described in JP 2002193709 and in WO 01/00614. Pyriprole and its preparation are described in WO 98/45274 and in U.S. Pat. No. 6,335,357. Amidoflumet and its preparation are described in U.S. Pat. No. 6,221,890 and in JP 21010907. Flufenerim and its preparation are described in WO 03/007717 and in WO 03/007718. Cyflumetofen and its preparation are described in WO 04/080180.

Anthranilamides of the formula (XIV) and their preparation are described in WO 01/70671; WO 02/48137; WO 03/24222, WO 03/15518, WO 04/67528; WO 04/33468; and WO 05/118552.

Further mixing partners which are possible are amidrazones of the formula (IX),

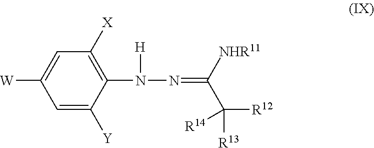

where the symbols have the following meanings:
W is Cl or CF₃;
X, Y are identical or different Cl or Br;
R¹¹ is (C₁-C₆)-alkyl, (C₃-C₆)-alkenyl, (C₃-C₆)-alkynyl or (C₃-C₆)-cycloalkyl, each of which can be substituted by 1 to 3 halogen atoms, or (C₂-C₄)-alkyl which is substituted by (C₁-C₄)-alkoxy;
R¹², R¹³ are (C₁-C₆)-alkyl or together with the carbon atom to which they are bonded form (C₃-C₆)-cycloalkyl which can be substituted by 1 to 3 halogen atoms;
R¹⁴ is H or (C₁-C₆)-alkyl,
   and enantiomers and salts thereof.

Preferably, the symbols of the formula (IX) have the following meanings:
R¹¹ is preferably (C₁-C₄)-alkyl, in particular methyl or ethyl;
R¹² and R¹³ are preferably methyl or together with the carbon atom to which they are bonded form a cyclopropyl ring which can have attached to it one or two chlorine atoms;
R¹⁴ is preferably (C₁-C₄)-alkyl, in particular methyl;
W is preferably CF₃;
X, Y are preferably Cl.

Furthermore preferred compounds of the formula (IX) are those in which X and Y are Cl, W is CF₃, R¹², R¹³ and R¹⁴ are methyl and R¹¹ is methyl or ethyl, and also those compounds in which X, Y are Cl, W is CF₃, R¹², R¹³ together with the carbon atom to which they are bonded form a 2,2-dichlorocyclopropyl group, R¹⁴ is methyl and R¹¹ is methyl or ethyl. These compounds and their preparation are described for example in US 2007/0184983.

Preferred mixing partners—besides mixtures of the compounds employed in accordance with the invention with one another—are pyrethroids (I.3), neonicotin receptor agonists/antagonists (I.5), borates, carbaryl, chlorantraniliprole, chlorpyrifos, diflubenzuron, fenitrothion, flonicamid, flufenoxuron, hexaflumuron, indoxacarb, isofenphos, noviflumuron, metaflumizone, spinosad, sulfluramid. Especially preferred are acetamiprid, bifenthrin, cyfluthrin, cyhalothrin, cypermethrin, alpha-cypermethrin, deltamethrin, fenvalerate, imidacloprid, lambda-cyhalothrin, permethrin, thiacloprid and thiamethoxam.

Very especially preferred are mixtures of fipronil with one or more of the abovementioned mixing partners, in particular fipronil with α-cypermethrin and/or piperonyl butoxide (PBO). Furthermore especially preferred is the use of fipronil without a further mixing partner.

The mixing ratio between the insecticides employed in accordance with the invention and, if appropriate, further mixing partners may vary within wide limits and is generally from 0.1:100 to 100:0.1.

The insecticide, or insecticide mixture, can be employed as pure substance (for example as a technical grade, or pure, active substance). The use of commercially available formulations is also possible.

The amount of insecticide, or insecticide mixture, which is added to the polymer melt is chosen such that the XPS preforms obtainable therefrom have concentrations of from 10 to 1000 ppm, especially preferably from 20 to 1000 ppm and very especially preferably from 50 to 500 ppm.

Step (c) of the method according to the invention comprises the foaming of the foamable melt in order to obtain an XPS preform.

To this end, the melt is conveyed through a suitable device, for example a die plate. The die plate is heated to at least a temperature of the blowing-agent-comprising polymer melt. The temperature of the die plate is preferably 50 to 200° C. The temperature of the die plate is especially preferably 100 to 150° C.

The blowing-agent-comprising polymer melt is transferred through the die plate into a zone in which a lower pressure prevails than in the zone in which the foamable melt is held before extrusion through the die plate. The lower pressure can be superatmospheric or subatmospheric. Extrusion into a zone with atmospheric pressure is preferred.

Step (c) is also carried out at a temperature at which the polymeric material to be foamed is present in the molten state, in general at temperatures of from 50 to 150° C., preferably at from 100 to 125° C. By conveying the blowing-agent-comprising polymer melt, in step (c), into a zone in which a lower pressure prevails, the blowing agent is brought into the gaseous state. As a result of the great increase in volume, the polymer melt is expanded and foamed.

The geometric shape of the cross-section of the XPS preforms obtainable by the process according to the invention is determined essentially by the choice of the die plate and can be varied within wide ranges. Thus, it is possible to employ, for example, die plates whose outlet opening has one of the following shapes: circle, triangle, quadrangle (square, rectangle, rhombus, trapezoid, parallelogram, lozenge, quadrangle enscribed in a circle, deltoid, quadrangle circumscribed about a circle), pentagon, hexagon, heptagon, octagon, nonagon, decagon and n-agonal shapes with n=11 to 100, and also ellipse and circle. Others which are suitable include complex shapes such as pentagram, hexagram, superellipse, spherical lune, spherical triangle and cycloid, and all shapes which result from combinations of the shapes mentioned here with one another.

The XPS preforms obtainable by the process according to the invention preferably have a right-angled cross section. The thickness of the XPS preform is determined by the height of the slit of the die plate. The width of the XPS preform is determined by the width of the die-plate slit. The length of the preform is determined in a downstream step by methods known to the skilled worker, such as bonding, welding, sawing and cutting. Particularly preferred are XPS preforms with a sheet-like geometry (XPS sheets). Sheet-like means that the dimension of the thickness(height) is small in comparison with the dimension of the width and the dimension of the length of the preform.

As a rule, the XPS preforms according to the invention have a compressive strength, measured as specified in DIN EN 826, in the range of from 0.3 to 1.0 N/mm², preferably in the range of from 0.35 to 0.7 N/mm². The density of the foam sheets is preferably in the range of from 25 to 50 kg/m³. The XPS sheets according to the invention preferably have cells at least 90% of which, in particular 95 to 100% of which, are of closed-cell type, measured as specified in DIN ISO 4590.

As the result of the distribution of the insecticide in the polymer melt, the insecticide is firmly incorporated into the polymer matrix in the insecticide-modified XPS preforms according to the invention. This reduces active substance loss and exposure to the insecticide during preparation, processing and use of the XPS preforms. In addition, the process according to the invention allows the insecticide quantity required to be reduced.

In one embodiment, the insecticide, or insecticide mixture, is in the form of a molecular dispersion in the XPS preforms according to the invention.

In the form of a molecular dispersion means according to the invention that the active substance is so finely distributed in the polymer matrix that no crystalline amounts of the active substance can be identified by X-ray diffractometry. Such a state is also referred to as a “solid solution”.

Since the detection level for crystalline amounts is approximately 3% by weight in the case of X-ray diffractometry, the term “no crystalline amounts” means that less than 3% by weight of crystalline amounts are present. The state of the molecular dispersion can be determined with the method referred to as differential scanning calorimetry (DSC). In the case of molecular dispersion, a melting peak can no longer be detected around the melting point of the active substance. The detection limit of this method is 1% by weight.

Solid solutions result in an improved release of the active substance. An important demand made of solid solutions is that they are also stable upon storage over prolonged periods, i.e. that the active substance does not crystallize. Moreover, the capacity of the solid solution, in other words the ability to form stable solid solutions with the highest possible active substance contents, is also important.

The invention also relates to the use of the XPS preforms according to the invention.

Preferred is the use of the XPS preforms produced in accordance with the invention in the construction industry, for example as insulation material below and above ground for avoiding or reducing damage of the preforms by pests such as, for example insects, which can inflict substantial feeding damage to the preforms, so that the insulation effect and the mechanical stability of the preforms are limited and further penetration of the pests is made possible. The preforms produced in accordance with the invention are especially suitable for avoiding or reducing damage by termites.

The invention is illustrated in greater detail by the examples, without being limited thereby.

### Preparation of Termiticidal Extruded PS Foams:

### EXAMPLE ACCORDING TO THE INVENTION

### 1. Coating PS Granules

6985 g of polystyrene granules (Polystyrol 158k, BASF SE) were admixed with 15 ml of a suspension concentrate comprising 500 g/l of fipronil in a stirrer from Alexanderwerk. The mixture was subsequently dried at RT.

### 2. Preparation of Termiticide-(Fipronil)-Comprising Foams in the Extruder

The components of Table 1 are mixed in a twin-screw extruder (ZSK 25):

TABLE 1

| | Product 1 | | | |
|---|---|---|---|---|
| | (reference | | | |
| | without active | | | |
| | substance) | Product 2 | Product 3 | Product 4 |
| PS 158K granules | 6805 | 6455 | 6105 | 5405 |
| PS 158K + | 0 | 350 | 700 | 1400 |
| fipronil of | | | | |
| Example 1 | | | | |
| Additive mixture | 195 | 195 | 195 | 195 |
| (color, graphite, | | | | |
| flame retardant, | | | | |
| talc) | | | | |
| Carbon dioxide | 231 | 231 | 231 | 231 |
| Ethanol | 161 | 161 | 161 | 161 |
| Amount produced | 7392 g | 7392 g | 7392 g | 7392 g |

Here, fipronil-coated PS granules are the fipronil source (product of Example 1) which is metered in and which is mixed with the other components in the respective mixing ratios. The extrusion temperature is no more than 200° C. The mixture is foamed through a slot die of 22 mm width at a throughput of 7 kg/h.

### Comparative Example

### 3. Coating PS Granules

100 g of a deltamethrin active substance formulation (Decis Micro) (deltamethrin 62.5 g a.i./kg, Bayer Crop Science) were mixed with 100 ml of water. The mixture was placed into a stirrer from Alexanderwerk together with 6150 g of polystyrene (PS 158k; BASF SE) and mixed. The mixture was dried overnight.

### 4. Preparation of Termiticide-(Deltamethrin)-Comprising Foams in the Extruder

The components of Table 2 are mixed in a twin-screw extruder (ZSK 25):

TABLE 2

| | Product 5 | Product 6 | Product 7 | Product 8 |
|---|---|---|---|---|
| PS 158K granules | 6455 | 6105 | 5405 | 4005 |
| PS 158K + | 350 | 700 | 1400 | 2800 |
| deltamethrin of | | | | |
| Example 3 | | | | |
| Additive mixture | 195 | 195 | 195 | 195 |
| (color, graphite, | | | | |
| flame retardant, | | | | |
| talc) | | | | |
| Carbon dioxide | 231 | 231 | 231 | 231 |
| Ethanol | 161 | 161 | 161 | 161 |
| Amount produced | 7392 g | 7392 g | 7392 g | 7392 g |

Here, the deltamethrin-coated PS granules (product of 3) acts as the deltamethrin source, which is metered in and mixed with the further components in the respective mixing ratios.

The extrusion temperature is no more than 200° C. The mixture is foamed through a slot die of 22 mm width at a throughput of 7 kg/h.

### Determination of the Active Substance in the XPS Foam:

The content was analyzed by means of GC/MS. To this end, 0.5 g of the XPS are dissolved in acetonitrile and an aliquot of this solution, in diluted form, is subjected to quantitative analysis by means of GC/MS (Agilent GC: 6890N with an MS D 5973 detector). The results are shown in Tables 3 and 4.

TABLE 3

| Product | 1 | 2 | 3 | 4 |
|---|---|---|---|---|
| Fipronil (ppm] | 0 | 21 | 168 | 204 |

TABLE 4

| Product | 5 | 6 | 7 | 8 |
|---|---|---|---|---|
| Deltamethrin [ppm] | 65 | 113 | 209 | 398 |

### Biological Test of the XPS Foams:

The biological test method selected was similar to the biological test method of Su et al. (1993) for the determination of the activity of soil termiticides. Using a drilling machine equipped with a tap borer, cylinders (approximately 2.5 cm in diameter and 5.0 cm in length) were cut from blocks. Each polystyrene cylinder was wedged into a Tenite® polyester tube of diameter 2.5 cm. This tube was then connected via a Tygon connecting hose to another tube which comprised 80 female worker termites and one soldier termite. The 5.0 cm polystyrene cylinders were placed between two 3 cm agar segments. The food and nesting material for the termites, used both in the tube with the termites and in the tube with the polystyrene cylinder, was Ponderosa pine shavings and paper strips. The two tubes were kept at 25° C. during the test time of 7 days.

The distance tunneled through the outer surface of the cylinder along the inner wall of the tube was recorded over 24 hours. Short (<10 mm) straight tunnels on the outer side of the cylinder were measured with a ruler. Longer, curved tunnels were measured by placing a section of a rubber band along the course of the tunnel and then measuring the length of the rubber band. The test was terminated after seven days. On termination, the mortality was determined, as was the length of the distance tunneled through the interior of the cylinder, by threading small pieces of 0.5 mm insulated telephone wire through the tunnels and after withdrawal of the wire measuring its length with a ruler. To determine the length of tunneling through the interior of the cylinder for any particular day, the ratio of the total length of the tunnel on the outer surface of the cylinder to the length of the tunnel for the particular day was calculated and the total length determined for tunneling in the interior of the cylinder was divided by this ratio.

TABLE 5

| | Average | Mean External | Mean Internal | Mean Total |
|---|---|---|---|---|
| | mortality | Tunneling | Tunneling | Tunneling |
| Treatment | (%) | (cm) | (cm) | (cm) |
| Product 2 | 46.6 | 3.0 | 0.8 | 3.9 |
| Product 3 | 87.7 | 1.1 | 0.4 | 1.5 |
| Product 4 | 85.2 | 1.5 | 0.4 | 1.9 |
| Product 1 | 23.9 | 5.7 | 3.4 | 9.1 |
| reference | | | | |
| without | | | | |
| fipronil | | | | |
| Product 5 | 23.7 | 3.0 | 1.3 | 4.3 |
| Product 6 | 26.2 | 1.9 | 1.3 | 3.2 |
| Product 7 | 23.1 | 1.3 | 1.4 | 2.7 |
| Product 8 | 24.4 | 0.4 | 0.5 | 0.8 |

1.-15. (canceled)

16. A process for the production of insecticide-modified extruded polystyrene foam (XPS) preforms, comprising the steps
(a) heating polystyrene (PS) until a polymer melt is formed,
(b) introducing a blowing agent into the polymer melt to form a foamable melt, and
(c) foaming the foamable melt to give an XPS preform,
wherein at least one insecticide from the group of the phenylpyrazoles, chlorfenapyr and hydramethylnone is introduced into the polymer melt in at least one of steps (a) and/or (b).

17. The process according to claim 16, wherein the at least one insecticide is incorporated into the polymer melt in step (a).

18. The process according to claim 16, wherein the at least one insecticide is incorporated into the polymer melt as pure substance, as formulation or in the form of a masterbatch.

19. The process according to claim 16, wherein the at least one insecticide is incorporated into the polymer melt in the form of an aqueous formulation.

20. The process according to claim 16, wherein the at least one insecticide is incorporated into the polymer melt in the form of a masterbatch.

21. The process according to claim 20, wherein the masterbatch has an insecticide concentration of from 1 to 15% by weight.

22. The process according to claim 20, wherein the masterbatch is mixed in step (a) with the polymer melt in a ratio of from 10:1 to 1:100.

23. The process according to claim 16, wherein the insecticide is fipronil.

24. The process according to claim 16, wherein at least one further insecticide is mixed in besides at least one of the abovementioned insecticides.

25. The process according to claim 24, wherein the further insecticide is selected from the group of the pyrethroids, neonicotin receptor agonists/antagonists, borates, carbaryl, chlorantraniliprole, chlorpyrifos, diflubenzuron, fenitrothion, flonicamid, flufenoxuron, hexaflumuron, indoxacarb, isofenphos, noviflumuron, metaflumizone, spinosad and sulfluramid.

26. The process according to claim 16, wherein the concentration of the at least one insecticide in the XPS preforms is 10 to 1000 ppm.

27. An XPS preform, obtainable by the process according to claim 16.

28. An insulation material comprising the XPS preform according to claim 27.

29. A material for the protection of buildings against termites comprising the XPS preform according to claim 27.

30. A method of protecting a building against termites comprising the step of building the XPS preform according to claim 27 into the foundation, the external walls or the roof of the building to be protected.
